(19) United States
(12) Patent Application Publication
(10) Pub. No.: US 2022/0298084 A1
(43) Pub. Date: Sep. 22, 2022

(54) GRANULES OF POLYHALITE, POTASH AND AMMONIUM SULPHATE AND A COMPACTION PROCESS FOR THE PRODUCTION THEREOF

(71) Applicant: ICL EUROPE COOPERATIEF U.A., Amsterdam (NL)

(72) Inventors: Khalil ABU-RABEAH, Beer Sheva (IL); Natalia GEINIK, Arad (IL); Ruben SOCOLOVSKY, Beer Sheva (IL); Yacov LEVY, Dimona (IL); Marina DAKOV, Arad (IL)

(21) Appl. No.: 17/619,766

(22) PCT Filed: Aug. 12, 2020
(86) PCT No.: PCT/IL2020/050883

§ 371 Date: Dec. 16, 2021

Related U.S. Application Data
(60) Provisional application No. 62/890,195, filed on Aug. 22, 2019.

(51) Int. Cl. C05G 1/00; C05G 5/12; C05G 5/40; C05D 1/02; C05C 5/02; C05D 1/00; C05C 5/00

(52) U.S. Cl. CPC C05G 1/00; C05G 5/12; C05G 5/40; C05D 1/02; C05C 5/02; C05D 1/005; C05C 5/005

(57) ABSTRACT

According to some embodiments of the present invention there is provided herein a compacted granule of Polyhalite, Potassium salt and an inorganic binder comprising a strength of 2.7 KgF/Granule when measured after production.

### FIELD OF THE INVENTION

The present invention relates to the field of fertilizers, specifically to production of compacted polyhalite and potash mixture to act as a fertilizer. The invention relates to deformation properties of fed raw material to produce a new product via a compaction process. The developed new process steps of compaction process provide the ability to reduce energy and production costs.

### BACKGROUND OF THE INVENTION

To grow properly, plants need nutrients (nitrogen, potassium, calcium, zinc, magnesium, iron, manganese, etc.) which normally can be found in the soil. Sometimes fertilizers are needed to achieve a desired plant growth as these can enhance the growth of plants.

This growth of plants is met in two ways, the traditional one being additives that provide nutrients. The second mode by which some fertilizers act is to enhance the effectiveness of the soil by modifying its water retention and aeration. Fertilizers typically provide, in varying proportions, three main macronutrients:

Nitrogen (N): leaf growth;
Phosphorus (P): Development of roots, flowers, seeds, fruit;
Potassium (K): Strong stem growth, movement of water in plants, promotion of flowering and fruiting;
three secondary macronutrients: calcium (Ca), magnesium (Mg), and sulphur (S); micronutrients: copper (Cu), iron (Fe), manganese (Mn), molybdenum (Mo), zinc (Zn), boron (B), and of occasional significance there are silicon (Si), cobalt (Co), and vanadium (V) plus rare mineral catalysts.

The most reliable and effective way to make the availability of nutrients coincide with plant requirements is by controlling their release into the soil solution, using slow release or controlled release fertilizers.

Both slow release fertilizers (SRF) and controlled release fertilizers (CRF) supply nutrients gradually. Yet, slow release fertilizers and controlled release fertilizers differ in many ways: The technology they use, the release mechanism, longevity, release controlling factors and more.

Solid fertilizers include granules, prills, crystals and powders. A prilled fertilizer is a type of granular fertilizer that is nearly spherical made by solidifying free-falling droplets in air or a fluid medium. Most controlled-release fertilizers (CRFs) used in commercial nurseries are prilled fertilizers that have been coated with sulfur or a polymer. These products have been developed to allow a slow release of nutrients into the root zone throughout crop development.

Polyhalite is an evaporate mineral, a hydrated sulfate of potassium, calcium and magnesium with formula: K₂Mg2Ca4(SO4)₂2H₂O Polyhalite is used as a fertilizer since it contains four important nutrients and is low in chloride:

48% SO₃ as sulfate

### 14% K₂O

### 6% MgO

### 17% CaO

Potash refers to potassium compounds and potassium-bearing materials, the most common being potassium chloride (KCl). Potassium is the third major plant and crop nutrient after nitrogen and phosphorus. It has been used since antiquity as a soil fertilizer (about 90% of current use). Elemental potassium does not occur in nature because it reacts violently with water. As part of various compounds, potassium makes up about 2.6% of the weight of the Earth's crust and is the seventh most abundant element, similar in abundance to sodium at approximately 1.8% of the crust. Potash is important for agriculture because it improves water retention, yield, nutrient value, taste, color, texture and disease resistance of food crops. It has wide application to fruit and vegetables, rice, wheat and other grains, sugar, corn, soybeans, palm oil and cotton, all of which benefit from the nutrient's quality enhancing properties.

### SUMMARY OF THE INVENTION

According to some demonstrative embodiments, there is provided herein a granule of Polyhalite, Potassium salt and an inorganic binder.

According to some embodiments, the granule comprises a strength of 2.7 KgF/Granule when measured after production.

According to some embodiments, the granule comprises a strength of 2.9 KgF/Granule when measured 24 hours after production.

According to some embodiments, the granule comprises a strength of 3.1 KgF/Granule when measured 48 hours after production.

According to some embodiments, the granule comprises a PSD of 2.0-4.75 mm define as granular and Minis in the range of 0.7-2 mm

According to some demonstrative embodiments, there is provided herein a process for the compaction of Polyhalite with a Potassium salt together with an inorganic binder.

According to some embodiments, the use of a binder in the compaction process has been surprisingly effective in yielding a superior quality granule of polyhalite and the Potassium salt.

According to some embodiments, the process may include: mixing a feed of polyhalite with a feed of said Potassium salt and binder in a mixer to yield a mixture; compacting said mixture in a compactor to yield masses; crushing said masses in a crusher to yield particles; and screening said particles in a screener to yield different particles in three different sizes: oversized fine particles which undergo a second crushing process and are retuned to said screener for screening, undersized fine particles which are transferred to said mixer for further mixing, and desired size granular particles which are transferred to a polish screener.

According to some embodiments, the Potassium salt may include at least one of Potash, Potassium Nitrate and Potassium Sulphate, or any other form of Potash.

According to some preferred embodiments, the Potassium salt is Potash.

According to some embodiments, the binder may be selected from a group including ammonium compounds like ammonium sulphate, ammonium nitrate ammonium carbonate.

According to some embodiments, the binder is preferably Ammonium Sulphate.

According to some embodiments, the binder may be added to the mixer with said feed of Polyhalite and said feed of Potassium salt.

According to some embodiments, the process is a dry process wherein said mixture is optionally heated in a heater after being mixed in said mixer.

### DETAILED DESCRIPTION OF THE INVENTION

According to some demonstrative embodiments, there is provided herein a granule of Polyhalite, Potassium salt and an inorganic binder.

According to some embodiments, the granule comprises a strength of 2.678 KgF/Granule when measured after production.

According to some embodiments, the granule comprises a strength of 2.902 KgF/Granule when measured 24 hours after production.

According to some embodiments, the granule comprises a strength of 3.093 KgF/Granule when measured 48 hours after production.

According to some embodiments, the granule comprises a PSD of 2.0-4.75 mm.

According to some demonstrative embodiments, there is provided herein a process for the compaction of Polyhalite with a Potassium salt together with an inorganic binder.

According to some embodiments, the use of a binder in the compaction process has been surprisingly effective in yielding a superior quality granule of Polyhalite and the Potassium salt.

According to some embodiments, the process may include: mixing a feed of Polyhalite with a feed of said Potassium salt and binder in a mixer to yield a mixture; compacting said mixture in a compactor to yield masses; crushing said masses in a crusher to yield particles; and screening said particles in a screener to yield different particles in three different sizes: oversized fine particles which undergo a second crushing process and are retuned to said screener for screening, undersized fine particles which are transferred to said mixer for further mixing, and desired size granular particles which are transferred to a polish screener.

According to some embodiments, the process may preferably include compacting a maximum of 60% w/w standard Potash and a maximum of 60% w/w Polyhalite.

According to some embodiments, when a binder and/or an additive is added, there is less than 50% w/w of Potash and less than 50% w/w Polyhalite.

According to some embodiments, the compaction may include a dry compaction and according to other embodiments, the compaction may optionally be a wet compaction.

According to some embodiments, the Potassium salt may include at least one of Potash, Potassium Nitrate and Potassium Sulphate, or any other form of Potash.

According to some embodiments, the Potassium salt may preferably be Potash.

According to some embodiments, the binder may be selected from a group including ammonium compounds like ammonium sulphate, ammonium nitrate and ammonium carbonate any other form

According to some embodiments, the binder is preferably Ammonium Sulphate.

According to some embodiments, the binder may be added to the mixer with said feed of Polyhalite and said feed of Potassium salt.

According to some demonstrative embodiments, the binder may be added in a concentration ranging between 0.1-20% w/w, preferably between 2-5% w/w.

According to some demonstrative embodiments, the addition of a binder to the process improves plastic deformation properties, and may therefore have a positive effect on the compaction process, e.g., since it enhances the strength of the resulting granules (also referred to herein as flakes) and diminishes the abrasion of the final product, e.g., when the final resulting product is transported.

According to some embodiments, the resulting product may have a low abrasion level.

According to some embodiments, as is known in the art a usual process of compaction does not require the use of a binder due to the shear forces applied to the materials yielding a compressed granule.

However, according to some demonstrative and preferable embodiments of the present invention an Ammonium salt may be used as a binder in the process of the present invention, e.g., for the reasons detailed herein.

According to some demonstrative embodiments, it is estimated that the unique use of ammonium salts as binder in the compaction process provided herein may yield a compacted granule possessing advantageous characteristics, e.g., when compared to ordinary compaction processes.

According to some embodiments, the exact mechanism of adherence resulting from the addition of ammonium salts, specifically ammonium sulphate, it yet to be established.

It is estimated however that Ammonium salts may chemically react with the calcium Sulphate in the Polyhalite to yield Ammonium Syngenite. According to some demonstrative embodiments, this process may specifically occur when Polyhalite is in the form of fine particles.

According to some demonstrative embodiments, it is hypothesized that a reaction between Ammonium Sulphate and calcium Sulphate may occur during the process of the present invention.

According to some embodiments, the compaction process is preferably a wet process as water enhances the chemical and physical reactions, for example, the bonding reaction between Ammonium sulphate and Polyhalite.

According to some embodiments, there may also be an effect on the deformation properties of the granule. The agglomeration (or any other mechanism of particle adhesion) prior to compaction step may optionally take place.

According to some embodiments, the process is a dry process wherein said mixture is optionally heated in a heater after being mixed in said mixer. Heated in either/and in mixer, preheater and during the compaction process. According to some embodiments, as detailed herein, the heating process, if utilized, may require substantially less heat than ordinary compaction processes.

According to some preferable embodiments, when the compaction is a wet compaction, in which in addition to the binder, water may be added as well.

According to some embodiments, the addition of water may enhance the formation of bonds between Ammonium Sulphate and Polyhalite, in addition to a lubrication effect.

According to some embodiments, when the potassium salt and/or Polyhalite are in fine particle form, the use of an ammonium salt as binder may provide superior adherence properties, and the process may also result in less recycling.

According to some embodiments, the addition of Ammonium Sulphate allows for the compaction process to take place at ambient temperatures, for example, in contrast to a compaction process without Ammonium Sulphate which requires compaction of Polyhalite and potash at relatively high temperature, e.g., around 110-160° C.

According to some embodiments, as mentioned hereinabove, it is estimated that during the compaction process of the present invention Ammonium Syngenite may be yielded. Ammonium Syngenite may enable stronger chemical bonding during the compaction process, obviating the need to use heating.

According to some embodiments, in addition to the compaction step, the process described herein may possess superior characteristics, as it may enable the feeding of the materials into a compactor at lower temperatures, e.g., in comparison to the ordinary compaction process of Polyhalite.

According to some embodiments, refraining from using elevated temperatures during the process may substantially save costs and According to some embodiment using ambient temperature during the process may substantially save costs and energy.

According to some embodiments, the granule resulting from the process of the present invention may possess superior quality in comparison to other granules containing only Polyhalite (or Polyhalite and other binders). According to some embodiments, the term “superior quality” as used herein may refer to a granule having prolonged shelf life, better spherical shape and/or uniform spherical characteristics, improved dissolution rates, diminished dusting effect and the like.

According to some embodiments, when Ammonium Sulphate is used in the compaction process and this yields a small portion of material to be recycled, e.g., in comparison to a process lacking a binder.

According to some demonstrative embodiments, the dry compaction process may include the following steps:

Mixing Potash with Polyhalite, optionally with a binder like ammonium compounds

The mixture may be heated to a temperature between 80-180° C., preferably 160° C.

According to some embodiments, if Ammonium Sulphate is used as a binder, the process may be conducted at substantially lower temperatures (preferably not exceeding 100° C., more preferably between 20° C.-80° C., most preferably between 40° C.-70° C.),

Feeding the mixture into a compactor to provide compacted flakes;

Grinding of the flakes;
Sieving of the grinded flakes; and

According to some embodiments, after sieving there are three types of yield:

1. Desired sized flakes—between 10-17 mm thickness, S.G. between 1.9 to 2.4 g/cm³. According to some embodiments, the desired size of the flakes (also referred to herein as “particles” or “granules”) is between 1-6 mm, most preferably between 2-4.75 mm.
2. Oversized (OS) flakes—are returned to the grinding stage, e.g., between 4-20% w/w of the total resulting flakes.
3. Undersized (US) flakes—are returned to the mixture for 1.0 compaction, e.g., between 10 to 70% w/w of the total resulting flakes.

According to some embodiments, in the dry process, optionally a binder may be added in a solid form, preferably between 0.5%-20% w/w, most preferably between 2-5% w/w.

According to some embodiments, oil may be added to the resulting granules, e.g., to improve the rheology of the product and diminish dust formation. For example, in an amount between 500-10,000 ppm, preferably 3000-5000 ppm, more preferably 3000 ppm. According to some embodiments, any suitable anti-dusting agent may be used, including for example, mineral oil or similar, slack wax or similar, paraffin wax, similar or mixture of them or other inorganic, hydrocarbon, polysugars or natural source additives.

According to some embodiment coating material may be added to the granules.

According to some demonstrative embodiments, the process may include unique conditions to enable to effective compaction of raw material mixture, including high temperatures ranging from 80 to 190° C. preferably 160° C. and high force conditions ranging from 45 to 100 kN/cm, preferably 55 kN/cm and Flack thickness between 1.4 mm to 33 mm. According to some embodiments, the desired size of the flakes is between 1-6 mm, most preferably between 2-4 mm.

According to some demonstrative embodiments, the present invention allows for the effective compaction of polyhalite which is difficult to compact under regular conditions due to the difficulty in achieving deformation of polyhalite particles.

According to some embodiments the addition of Potash, Phosphate compounds or Potassium Nitrate to Polyhalite and the unique conditions described herein enable to overcome the difficulties of compacting Polyhalite and to effectively provide compacted granules of with addition of phosphate compounds, Potash, Potassium Nitrate or Potassium Sulfate

According to some demonstrative embodiments, the process of the present invention may also be effective when Potash is replaced with Potassium Nitrate and/or Potassium Sulphate. In these cases, the Phosphates compounds or Potassium Nitrate will be added to Polyhalite and the unique conditions described herein enable to overcome the difficulties of compacting Polyhalite and to effectively provide compacted granules of Polyhalite with potash, phosphate compounds or potassium Nitrate or Potassium Sulfate optionally with addition of a binder.

According to some embodiments, the process may include wet compaction, wherein the process is carried out in a temperature ranging from ambient temperature ˜20° C. to 100° C.

According to these embodiments, in wet compaction the process includes the following steps:

Mixing Potash with Polyhalite, optionally with a binder at ambient temperature;

Feeding the mixture into a compactor with water addition 0.1-1.2% to provide wet compacted flakes; Grinding of the flakes;

The water have an advantageous effect on the curing of the final product, which cause enhanced shelf life.

Sieving of the grinded flakes; and

According to some embodiments, after sieving there are three types of yield:

1. Desired sized flakes—from 10-17 mm thickness, S.G. between 1.9 to 2.4 g/cm3
2. Oversized (OS) flakes—are returned to the grinding stage, e.g., between 4-20% of the yield.
3. Undersized (US) flakes—are returned to the mixture for compaction According to these embodiments, the wet compaction process includes heating the desired size granules in order to evaporate any water residues from the granules, resulting in dry granules. According to some embodiments, the granules are heated to a temperature of between 70-160° C., preferably 140° C., depending on the dryer ability and the possible retention time.

According to some embodiments the wet compaction process allows for the compaction of Polyhalite at high concentrations from 10% to 100%, preferably 44% of Polyhalite.

According to some embodiments, the binder in the wet process may include fly ash, starch, lignosulphonates, hydrocarbons, calcium oxide and/or calcium hydroxide.

According to some embodiments, to the resulting flakes additives may be added, including for examples, nutrients, minerals, coating materials, sustained release compounds and the like.

According to some embodiments, the nutrients may include:

Nitrogen (N): leaf growth;
Phosphorus (P): Development of roots, flowers, seeds, fruit;
Potassium (K): Strong stem growth, movement of water in plants, promotion of flowering and fruiting;
three secondary macronutrients: calcium (Ca), magnesium (Mg), and Sulphur (S);
micronutrients: copper (Cu), iron (Fe), manganese (Mn), molybdenum (Mo), zinc (Zn), boron (B), and of occasional significance there are silicon (Si), cobalt (Co), and vanadium (V) plus rare mineral catalysts etc.

According to some embodiments, the mixture of the present invention may also include additional fertilizer besides Potash and Polyhalite.

According to some demonstrative embodiments, the term “fertilizer” may include any material of natural or synthetic origin that is applied to soils or to plant tissues to supply one or more plant nutrients essential to the growth of plants, including, for example, Single nutrient (“straight”) fertilizers such as Ammonium nitrate, Urea, calcium ammonium nitrate, superphosphate, e.g., “Single superphosphate” (SSP), phosphogypsum, Triple superphosphate (TSP) or a mixture thereof; Multinutrient fertilizers such as Binary (NP, NK, PK) fertilizers, e.g., monoammonium phosphate (MAP) and/or diammonium phosphate (DAP), NPK fertilizers which are three-component fertilizers providing nitrogen, phosphorus, and potassium; fertilizers which include one or more of the main micronutrients sources of iron, manganese, boron, molybdenum, zinc, and copper and the like; Compound fertilizers, e.g., which contain N, P, and K; Organic fertilizers such as peat, animal wastes, plant wastes from agriculture, and sewage sludge; and/or Other elements such as calcium, magnesium, and sulfur.

According to some embodiments, the fertilizer preferably includes one or more of nitrogen fertilizers such as ammonia, anhydrous ammonium nitrate, urea and sodium nitrate; Phosphate fertilizers; Potassium fertilizers, such as Potash, potassium chloride, potassium sulfate, potassium carbonate, or potassium nitrate

According to some embodiments, the bunder is preferably Ammonium Sulphate.

According to some demonstrative embodiments, the sieving is done using a siever having opening with a diameter of between 1.4-4.75 mm preferably between 2-4.75 mm.

According to some embodiments, the mixing is performed in a blade blender and/or any other suitable devise capable of having a rotation speed that creates a swirling motion for a perfect homogenization and a high blending precision, e.g., a Ploughshare® Mixer. The mixing step has crucial action of providing primary chemical reaction in parallel to physical consolidation of the particles, such as agglomeration or any other pre-granulation step mechanism.

According to some embodiments, the resulting flakes/granules may be glazed and further coated with a suitable coating. For example, the coatings may include biodegradable coatings, sustained release coatings, controlled release coatings, oily coatings, wax coatings, starch coating or any other additive to contribute to quality and shelf life of the final product.

### Example—1

| Materials | Ratio (%) |
|---|---|
| Polysulphate | 43 |
| Potash | 53 |
| Ammonium Sulphate | 4 |
| Water | 0.1 |

The Polyhalite potash and ammonium sulphate were mixed and transferred to compactor.

The following conditions were set:

| Equipment Item | Value | Unit |
|---|---|---|
| Compactor | — | — |
| Roll Width | 300 | mm |
| Roll gap- off load | 10.1 | mm |
| Roll gap- load | 11.3 | mm |
| Roll speed | 24 | rpm |
| Screw Speed | 93-96 | rpm |
| Pressure | 264 | bar |
| Crusher | Hummer mill - impact | — |
| | flack breaker | |
| First Crusher Speed | 473-1500 | rpm |
| Second crusher speed | 473-1599 | rpm |
| Force feeder | 20-60 | rpm |
| diameter | 1 | m |

### Product Quality

| | Value | Unit |
|---|---|---|
| Strength | 2.7immediate | KgF/granule |
| Strength | 2.9 after 24 hr | KgF/granule |
| Strength | 3.1after 48 hr | KgF/granule |
| PSD | 2-4.75 mm | |

Part of the product subjected to post treatment by coating with by adding oil or anti dusting.

The product was kept in pile at ambient condition

The granules strength tested after production, After 24 hours and 48

While this invention has been described in terms of some specific examples, many modifications and variations are possible. It is therefore understood that within the scope of the appended claims, the invention may be realized otherwise than as specifically described.

### Example 2

Producing of 500 ton in full scale equipment

Samples took during production of the 500 ton. The data are an average value based on 16 samples/a

### Composition of Feed

MOP—50%

Polyhalite—45%

Ammonium Sulphate—4.5%

Water—0.5%

### Production Conditions

Temperature Ambient temperature

Speed of compactor 18 rpm

Pressure—214-235 bar

### Final Product

### Composition

SO3—23%

K—30.7%

Ca—5.7%

Mg—1.7%

### Granulometry

2 mm<98%<4.75 mm

### Hardness in KgF/GRANULE

After production—2.5

After 48 hr—3

### Abrasion

18%

1. A compacted granule of Polyhalite, Potassium salt and an inorganic binder comprising a strength of 2.7 KgF/Granule when measured after production.

2. The granule of claim 1, comprising a strength of 2,902 Kg F/Granule when measured 24 hours after production.

3. The granule of claim 1, comprising a strength of 3,093 Kg F/Granule when measured 48 hours after production.

4. The granule of claim 1, comprising a PSD of 2-4.75 mm.

5. The granule of claim 1, wherein said potassium salt is selected from the group including Potash, Potassium Nitrate and Potassium Sulphate or any other form of Potash.

6. The granule of claim 1, wherein said binder comprises ammonium compounds.

7. The granule of claim 1, wherein said binder is Ammonium Sulphate.

8. A process for the compaction of Polyhalite with a Potassium salt together with an inorganic binder.

9. The process of claim 8 comprising:
mixing a feed of Polyhalite with a feed of said Potassium salt, and water in a mixer to yield a mixture;
compacting said mixture in a compactor to yield masses;
adding said inorganic binder;
crushing said masses with said binder in a crusher to yield particles; and
screening said particles in a screener to yield different particles in three different sizes:
oversized fine particles which undergo a second crushing process and are retuned to said screener for screening,
undersized fine particles which are transferred to said mixer for further mixing, and
desired size granular particles which are transferred to a polish screener.

10. The process of claim 8, wherein said potassium salt is selected from the group including Potash, Potassium Nitrate and Potassium Sulphate or any other form of Potash.

11. The process of claim 8, wherein said binder comprises ammonium compounds.

12. The process of claim 8, wherein said binder is Ammonium Sulphate
